(19) United States
(12) Patent Application Publication
(10) Pub. No.: US 2002/0013770 A1
(43) Pub. Date: Jan. 31, 2002

(54) Information processing method, and method for making payment for information processing by electronic money

(76) Inventors: Toshikazu Higashi, Aichi-Ken (JP); Yoshiki Nakazawa, Toyokawa-Shi (JP); Kiyohito Tsujihara, Toyokawa-Shi (JP); Masahiro Nonoyama, Toyokawa-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/899,260

(22) Filed: Jul. 6, 2001

(30) Foreign Application Priority Data
Jul. 11, 2000 (JP) 2000-210275
Jul. 18, 2000 (JP) 2000-217419

(51) Int. Cl. G06F 17/60

(52) U.S. Cl. 705/40; 705/39

(57) ABSTRACT

When an information processing such as printing is requested through a network, whether the electronic money by which payment for the processing is made is valid or not is checked, and in response to reception of a result of the check that the electronic money is valid, the information processing is started. When a plurality of information processings are requested, by storing the data of each information processing so as to be related to electronic money, relation between each information processing data and the electronic money can be maintained even after the validity of the electronic money is checked.

### RELATED APPLICATION

This application is based on applications Nos. 2000-210275 and 2000-217419 filed in Japan, the entire content of which is hereby incorporated by reference.

### BACKGROUND OF THE INVENTION

1. Field of the Invention

The present invention relates to a payment system in which the user requests an information processing through a network and makes payment for the processing by electronic money, a payment method, an electronic money processor in which execution of an information processing is controlled in accordance with a result of a check of validity of electronic money, or an image forming apparatus having the electronic money processor.

2. Description of the Related Art

A system has previously been known in which the user's communication terminal and a printer are connected to a computer network such as a LAN and the printer performs print processing based on the print data transmitted from the user's communication terminal through the computer network. In this system, payment is usually made with a coin apparatus or an IC card apparatus connected to each printer.

However, the payment method using a coin apparatus or a card apparatus is inferior in operability because it is necessary for the user to take the trouble to go to the place where the printer is placed and insert a coin or set a card into the coin apparatus or the card apparatus connected to the printer.

To solve this problem, Japanese Laid-open Patent Applications Nos. H11-194686 and H10-55222 propose systems in which a printer and a charging server are connected through a computer network wherein a charging count corresponding to print processing is provided in the printer, the count values counted by the charging count in response to print processing are totaled up by the charging server (or a service center machine) simultaneously with or after print processing and payment processing is performed at a different time or by a different method from print processing. According to these systems, it is unnecessary for the user to take the trouble to go to the place where the printer is placed, so that operability improves.

However, with these systems, there is a problem that it is necessary to separately perform payment processing based on the total of the count values obtained by the charging server (or the service center machine). In addition, when it is found that the user is insolvent or the electronic money used is false one in the stage of payment processing, if print processing is performed therebefore, it is irrevocable. This problem arises when the user requests not only print processing but also processing such as translation processing or photo processing and transmits data to be processed together with electronic money through a network.

For example, in a system in which print processing is requested, generally, electric money data is transmitted from the printer to the charging server, and payment is made by the electronic money at the charging server. In the payment by electronic money, in order that the electronic money data and the print data waiting at the printer are related to each other, the transmitted electronic money data is processed in order of reception.

However, processing electronic money data in order of reception at the charging server presents a problem that stagnation of processing of one piece of electronic money data affects processing of succeeding electronic money data and processing of print data to increase the waiting time for the payment by electronic money and delay the start of the processing of the print data. This problem arises, like the above-mentioned problem, when the user requests not only print processing but also processing such as translation processing or photo processing and transmits data to be processed together with electronic money through a network.

### SUMMARY OF THE INVENTION

An object of the present invention is to solve the above-mentioned problems.

Yet another object of the present invention is to provide a system and a method for making payment by electronic money that enable reliable payment.

Still another object of the present invention is to provide a method for making payment by electronic money that is capable of reducing the waiting time for the payment by electronic money and the entire processing.

These and other objects are attained by an information processing method having the steps of receiving, through a network, data to be information-processed and electronic money by which payment for information processing is made, making a request that whether the received electronic money is valid or not be checked, and when the received electronic money is confirmed to be valid, automatically starting the processing of the data to be information-processed.

The above-mentioned objects of the present invention are also attained by an information processing method comprising the steps of receiving, through a network, data to be information-processed and electronic money by which payment for information processing is made; relating the received data to be information-processed and the electronic money by which payment for information processing is made, making a request that whether the received electronic money is valid or not be checked, and when the received electronic money is confirmed to be valid, performing the processing of the data to be information-processed related to the electronic money confirmed to be valid.

The invention itself, together with further objects and attendant advantages, will best be understood by reference to the following detailed description taken in conjunction with the accompanying drawings.

### BRIEF DESCRIPTION OF THE DRAWINGS

FIG. 1 is a general view of a payment system;

FIG. 2 is a block diagram showing the configuration of a printer;

FIG. 3 is a view showing the configuration of JOB data;

FIG. 4 is a view showing relating and separation of electronic money data and print data;

FIG. 5 is a flowchart showing the overall operation of the system;

FIG. 6 is a flowchart showing the operation of the printer;

FIG. 7 is a flowchart showing data relating processing according to another embodiment; and

FIG. 8 is a view showing a charged electronic money screen displayed on a PC.

In the following description, like parts are designated by like reference numbers throughout the several drawings.

### DESCRIPTION OF THE PREFERRED EMBODIMENT

Hereinafter, an embodiment of the present invention will be described with reference to the drawings.

[1. Configuration]

(1-1. Overall Configuration of System)

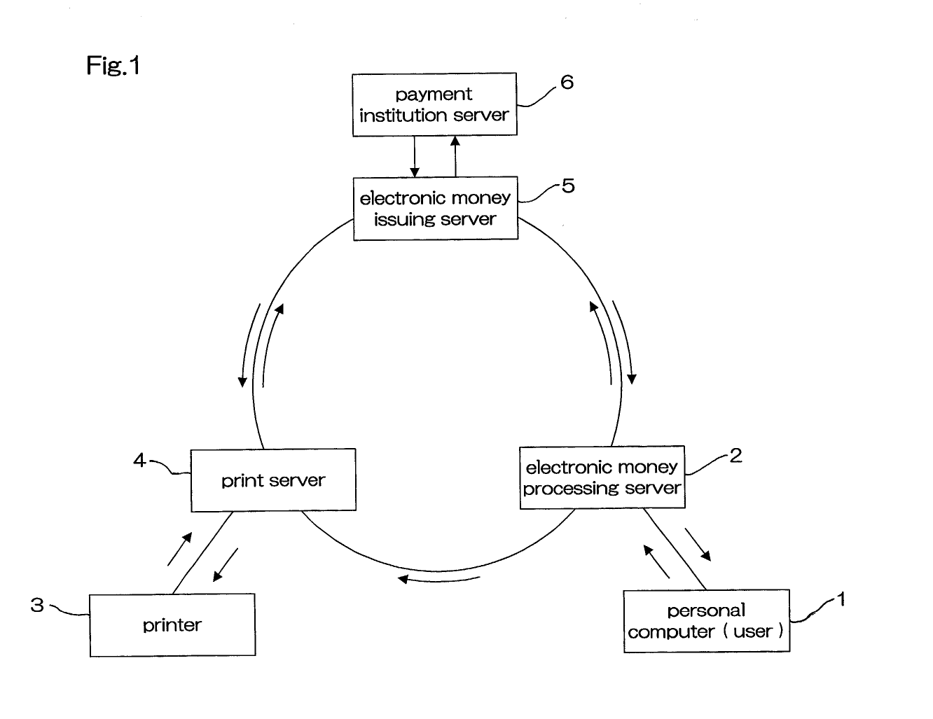

Referring to FIG. 1, reference number 1 represents a personal computer (hereinafter, referred to as PC) used by the user, and reference numeral 2 represents an electronic money processing server that requests for issuance of electronic money and performs procedures to issue electronic money. The PC 1 and the electronic money processing server 2 constitute a user side subsystem. Reference number 3 represents a printer, and reference numeral 4 represents a print server that manages the printer 3. The printer 3 and the print server 4 constitute a printer side subsystem. Reference number 5 represents an electronic money issuing server that issues electronic money, and reference numeral 6 represents a payment institution server that handles electronic money. The electronic money issuing server 5 and the payment institution server 6 constitute an electronic money issuer side subsystem. These subsystems constitute a payment system by being connected to one another through a network such as a LAN or the Internet. The electronic money issuing server 5 and the payment institution server 6 may be integrated.

Next, the relationship among the PC 1, the electronic money processing server 2, the printer 3, the print server 4, the electronic money issuing server 5 and the payment institution server 6 in these subsystems will be described concretely.

The PC 1, which has a keyboard and a mouse as well as a display portion such as a CRT (cathode-ray tube) display or an LCD (liquid crystal display), transmits through the network a request for issuance of a necessary amount of electronic money to the electronic money processing server 2 by a predetermined operation by the user. In this case, the necessary amount is predetermined based on the size, color and density, and a request for issuance of electronic money is transmitted in accordance with the necessary amount. Instead of doing this, the following may be performed: The necessary amount is determined by application software or the like by executing printing processing, and a request for issuance of electronic money is automatically transmitted in accordance with the necessary amount.

Receiving the request for issuance of electronic money from the PC 1, the electronic money processing server 2 transmits a request for issuance of electronic money to a predetermined electronic money issuing server 5 through the network.

Receiving the request for issuance of electronic money from the electronic money processing server 2, the electronic money issuing server 5 transmits a request for authentication to the payment institution server 6 to refer to a payment institution such as a bank for user authentication as to whether the electronic money can be issued to the user or not. By doing this, the issuer of the electronic money can check whether the user performs procedures necessary for issuing electronic money and the electronic money can be exchanged with actual currency or not.

The electronic money issuing server 5 receives the result of the user authentication from the payment institution server 6, and when determining that electronic money can be issued to the user, transmits through the network electronic money data and accompanying data to the electronic money processing server 2 that made the request.

Receiving the electronic money data from the electronic money issuing server 5, the electronic money processing server 2 delivers the electronic money data to the PC 1 through the network.

Receiving the electronic money data from the electronic money processing server 2, the PC1 adds the electronic money data to the print data as processing request data the processing of which is to be requested (hereinafter, referred to as JOB data), and transmits the JOB data to the printer 3 through the print server 4.

Receiving the JOB data from the PC 1, the printer 3 stores the print data included in the JOB data according to electronic money processing described later, and transmits part or all of the electronic money data to the electronic money issuing server 5 to check whether the electronic money included in the JOB data is valid or not.

The electronic money issuing server 5 checks whether the electronic money is valid or not based on the electronic money data transmitted from the printer 3, and transmits the result of the check of validity of the electronic money through the print server 4 to the printer 3 that transmitted the electronic money data.

The printer 3 determines whether the electronic money is valid or not based on the transmitted result of the check of validity of the electronic money, and when the electronic money is valid, executes print processing based on the print data corresponding to the electronic money data and being stored. When the print processing is completed, the printer 3 transmits a request for payment for the print processing to the electronic money issuing server 5.

Receiving the request for payment for the print processing transmitted from the printer 3, the electronic money issuing server 5 checks whether there is no problem with the payment request, and when there is no problem, transmits a request for payment to the payment institution server.

The payment institution server 6 makes payment in response to the payment request from the electronic money issuing server 5, and transmits the result of the payment to the electronic money issuing server 5.

(1-2. Printer Configuration)

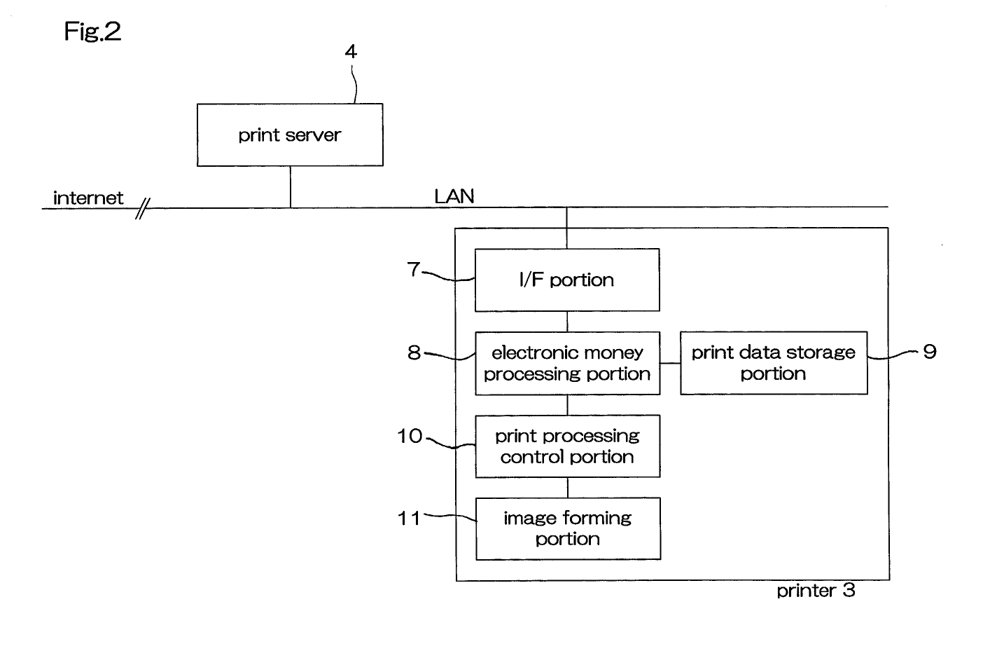

Next, the configuration of the printer will be described with reference to FIG. 2.

The printer 3 connected to the print server 4 through a LAN is managed by the print server 4. The LAN connecting the printer 3 and the print server 4 is also connected to the Internet.

The printer 3 comprises: an interface (I/F) portion 7 for inputting and outputting data on the network; an electronic money processing portion 8 that performs processings such as the check of the validity of electronic money and relating of electronic money and print data; a print data storage portion 9 in which print data is temporarily stored while the validity of electronic money is being checked; a print processing control portion 10 for performing printing based on the print data after the validity of the electronic money is checked; and an image forming portion 11.

The I/F portion 7 performs reception for taking JOB data on the network into the printer 3, transmission of electronic money data for checking whether the electronic money is valid or not, and reception of the result of the check of validity of the electronic money from the electronic money issuing server 5.

The electronic money processing portion 8 has the following functions: a function of determining whether the JOB data received by the I/F portion 7 includes electronic money data or not; a function of separating the electronic money data and the print data in the JOB data so as to be related to each other; a function of storing the print data into the print data storage portion 9; a function of taking out information on the issuer of the electronic money by analyzing the electronic money data; a function of comparing and examining information on the issuer of the electronic money and a table of information on transmission to the issuer of the electronic money (or information on transmission to what is referred to to obtain the table on the network); and a function of determining whether the electronic money is valid or not based on the result of the check of validity of the electronic money from the electronic money issuing server 5. That is, the electronic money processing portion 8 relates the electronic money data and the print data. Namely, the printer 3 includes the relating function.

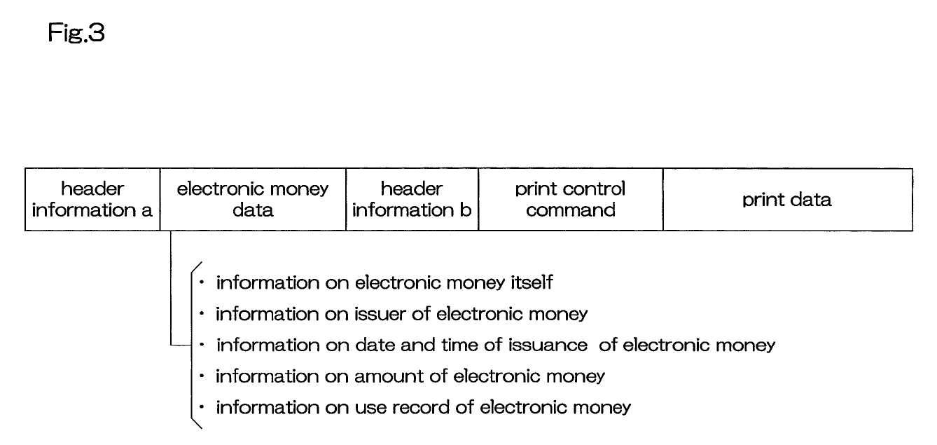

The JOB data has a configuration as shown in FIG. 3. In succession to header information a for distinguishing data on the network, electronic money data is present, followed by header information b, a print control command and print data like conventional data. The header information a includes data for determining that the JOB data is instruction data for executing print processing at the printer 3 and includes electronic money data.

The electronic money data includes information on the electronic money itself, information on the issuer of the electronic money, information on the date and time of issuance of the electronic money, information on the amount of the electronic money and information on the use record of the electronic money. Information on the issuer of the electronic money includes an address, on the network, of the issuer opened to the public and an issuer allocation code unique in a predetermined range of the network. Information included in the electronic money data includes information for validity check provided for a case where electronic money is circulated generally on the Internet, and information to be provided as electronic currency for electronic commerce having unique arrangements. To the electronic money data, necessary data can be added in accordance with the configuration of the electronic money used in the electronic commerce for which the printer 3 is intended.

The information on the electronic money itself is generally enciphered. The information attached to the print data is referred to by being deciphered, for example, with a password opened to the public. In this case, after deciphered, the information on the electronic money itself is transmitted to the issuer of the electronic money for a check. With respect to information that cannot be deciphered by ordinary users, the entire electronic money data is transmitted to the issuer of the electronic money for a check based on the above-mentioned attached related information.

Into the print data storage portion 9 which has a capacity sufficient for temporarily storing the print data included in the JOB data, the print data is stored so as to be related to the electronic money data in the same JOB data while the electronic money issuing server is checking the validity of the electronic money.

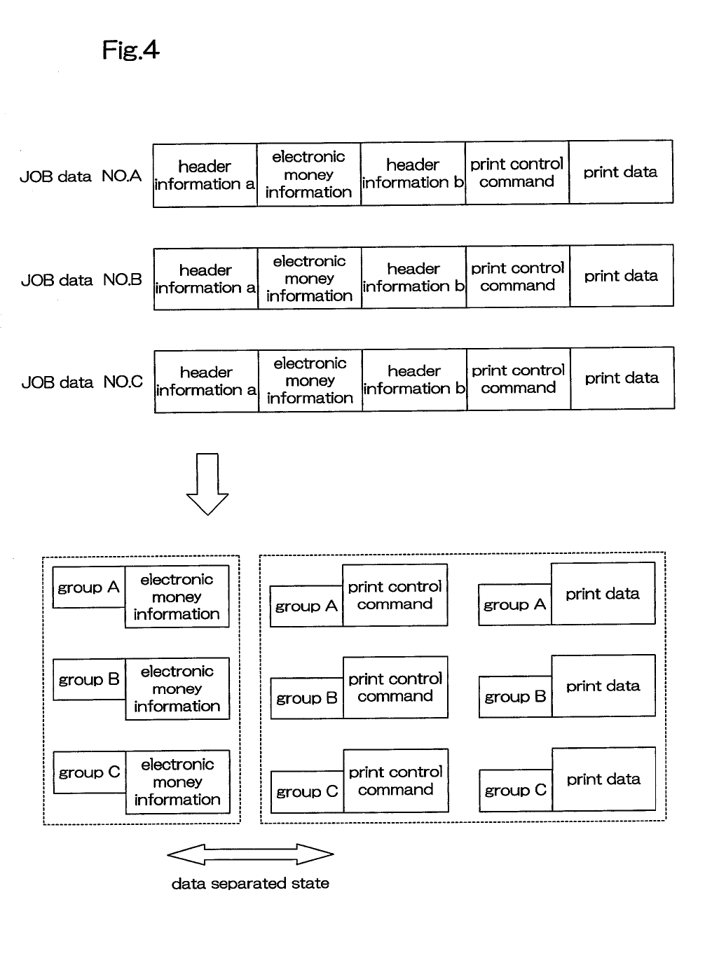

The method of relating the print data and the electronic money will be described concretely. As shown in FIG. 4, the electronic money processing portion 8 divides a plurality of pieces of JOB data received by the I/F portion 7 into groups (in this embodiment, into Groups A, B and C) by setting addresses by numbering in the order of reception, and then, separates the print data and the electronic money data of each piece of JOB data so as to be related to each other for each group number. Then, the electronic money processing portion 8 temporarily stores the separated print data into the print data storage portion 9 of the printer 3, and transmits the electronic money data to the electronic money issuing server for a check of the validity of the electronic money. By relating the print data and the electronic money data as described above, the print data is stored in a condition where it is related to the electronic money data by the group number, so that even when the reception of the result of the check of validity of the electronic money from the issuer of the electronic money in response to the transmission of the electronic money data is not in the order of input of JOB data, the print data corresponding to the electronic money data can be taken out immediately. Consequently, at the electronic money issuing server, electronic money data can be handled parallelly, so that the waiting time for the check of the validity of the electronic money and payment can be reduced.

The print data control portion 10 controls the execution of the print processing based on the print data corresponding to the electronic money and stored in the print data storage portion 9 in accordance with the result of the check of validity of the electronic money. The image forming portion 11 executes print processing based on the control of the execution of the print processing by the print data control portion 10. As described above, the printer 3 includes an electronic money processor.

### Operation

(2-1. Overall Operation of System)

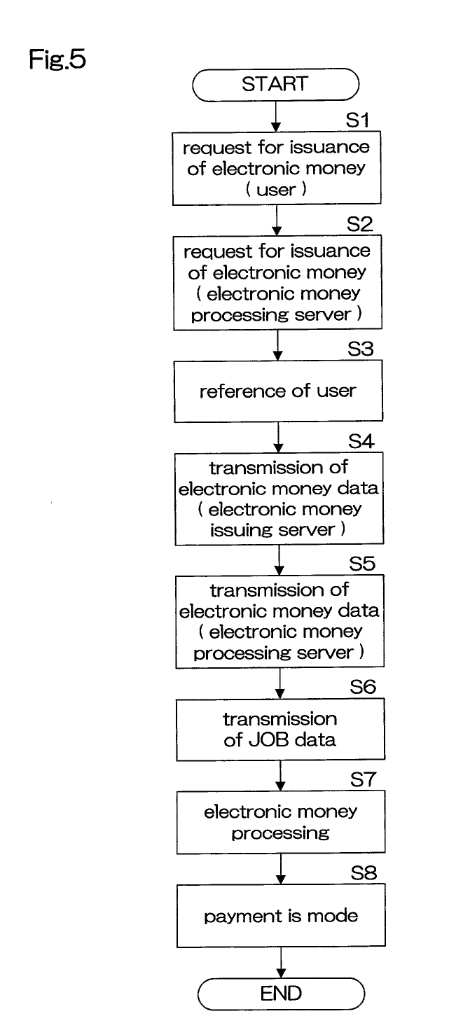

Next, the overall operation of the system will be described with reference to the flowchart of FIG. 5. In the description given below and the drawings, “step” is abbreviated as “S.”

First, at S1, the user transmits a request for issuance of a necessary amount of electronic money from the PC 1 to the electronic money processing server 2 by a predetermined operation. Then, at S2, the electronic money processing server 2 transmits a request for issuance of electronic money to a predetermined electronic money issuing server 5 through the Internet.

Then, at S3, the electronic money issuing server 5 transmits a request for authentication to the payment institution server 6 to refer to a payment institution such as a bank for user authentication as to whether the electronic money can be issued to the user or not. The electronic money issuing server 5 receives the result of the user authentication from the payment institution server 6, and when determining that the electronic Ad money can be issued to the user, at S4, transmits through the network electronic money data and accompanying data to the electronic money processing server 2 that made the request.

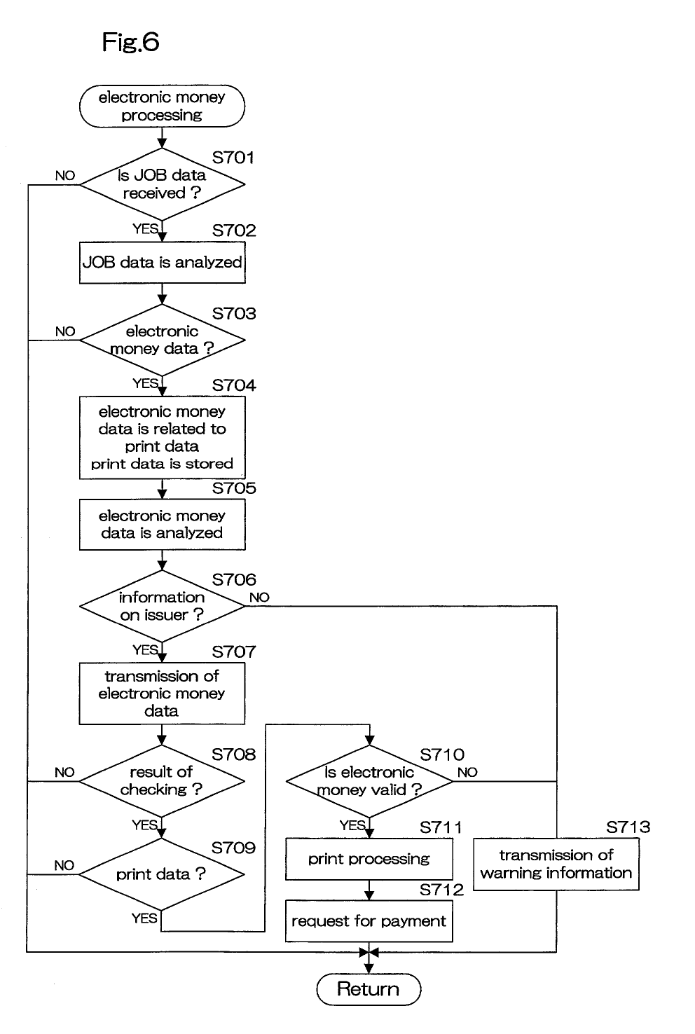

Then, at S5, after receiving the electronic money data from the electronic money issuing server 5, the electronic money processing server 2 delivers the electronic money data to the PC 1 through the network. At S6, the PC 1 adds the electronic money data to the print data (JOB data), and transmits the JOB data to the printer 3 through the print server 4. Then, at S7, the printer 3 executes the electronic money processing shown in the flowchart of FIG. 6.

After the electronic money processing by the printer 3, payment is made at S8. Specifically, after receiving a request for payment for the print processing transmitted from the printer 3, the electronic money issuing server 5 checks whether there is no problem with the payment request, and when there is no problem, transmits a request for payment to the payment institution server. The payment institution server 6 makes payment in response to the payment request from the electronic money issuing server 5, and transmits the result of the payment to the electronic money issuing server 5.

(2-2. Operation of Printer)

Next, the operation of the printer 3 (the electronic money processing at S7 of FIG. 5) will be described with reference to the flowchart of FIG. 6.

In the electronic money processing routine, at S701, the electronic money processing portion 8 of the printer 3 determines whether JOB data on the network is received by the I/F portion 4 or not. When JOB data is received (YES at S701), the process proceeds to S702, where the JOB data is taken in and expanded in the internal work area and the header information a of the JOB data is analyzed. Then, the process proceeds to S703. When no JOB data is received at S701, the process returns.

At S703, whether the JOB data includes electronic money data or not is determined. When the JOB data does not include electronic money data (NO at S703), the process returns. In this case, it is usually possible to provide a warning or to change the type of the currency used for the payment.

When the JOB data includes electronic money data (YES at S703), the process proceeds to S704, where the electronic money data is taken out from the JOB data for analysis. At this time, the print data and the electronic money data are separated so as to be related to each other for each group number as described above, and the separated print data is temporarily stored in the print data storage portion 9 in the printer 3.

Then, at S705, the electronic money data is analyzed, and the information on the issuer of the electronic money is taken out. Then, the process proceeds to S706. At this time, the decipherment of the information on the electronic money itself with a public key or the like as described above is included.

At S706, the information on the issuer of the electronic money analyzed at S705 and the electronic money issuer transmission information in the preregistered table are compared, and whether the corresponding electronic money issuer is present or not is checked. When the corresponding electronic money issuer is absent (NO at S706), the process proceeds to S713, where warning information for notifying the PC 1 that the print data of the absence is transmitted. When the corresponding electronic money issuer is present (YES at S706), the process proceeds to S707, where preparations for data transmission to the electronic money issuing server 5 are made. When data transmission is enabled, part or all of the electronic money data is transmitted to the electronic money issuing server 5, and the process proceeds to S708. When the information on the issuer of the electronic money includes information necessary for the network connection of the electronic money issuing server 5, the processing at S706 is unnecessary.

At S708, whether a result of the check of validity of the electronic money is received from the electronic money issuing server 5 or not is determined. When the result is not received (NO at S708), the process returns, and when the result is received (YES at S708), the process proceeds to S709.

At S709, it is determined whether the result of the check of validity of the electronic money received by the I/F portion 7 is a result of the check of validity of the electronic money corresponding to the print data temporarily stored in the print data storage portion 9 or not. When the received result is not a result of the check of validity of the electronic money corresponding to the print data (NO at S709), the process returns. When the received result is a result of the check of validity of the electronic money corresponding to the print data (YES at S709), the process proceeds to S710.

At S710, whether the electronic money is valid or not is determined based on the result of the check of validity of the electronic money. When it is determined that the electronic money is not valid (NO at S710), the process proceeds to S713, where warning information is transmitted to the PC 1 that sent the print data, and the print data is abandoned. When it is determined that the electronic money is valid (YES at S710), the process proceeds to S711, where print processing is executed by the print processing control portion 10 and the image forming portion 11 based on the print data. Then, the process proceeds to S712.

At S712, after the print processing is completed, a request for payment for the print processing is transmitted to the electronic money issuing server 5 through the print server 4.

Since the validity of the electronic money is checked and print processing based on the print data is performed in accordance with the result of the check as described above, print processing is prevented from being executed based on print data for which payment cannot be made, so that payment can be made easily and reliably.

Moreover, since the electronic money data and the print data are related so as to be associatable with each other and the print data corresponding to each electronic money data can be grasped easily and reliably as described above, the electronic money data and the print data can be processed parallelly. Consequently, even when a multiplicity of pieces of JOB data is present, the waiting time for payment by electronic money and the entire processing can be reduced.

In the above-described embodiment, a case where the processing requested by the user is print processing by the printer 3 is shown as an example. However, the processing requested by the user is not limited to print processing; it may be any processing for which payment can be made by electronic money such as translation processing by a translator or image processing by an image processor other than a printer.

While payment is made after the printer 3 completes print processing, payment may be made before print processing or during print processing.

While the printer 3 performs the above-described processings of electronic money, the print server 4 may perform the processings of electronic money. In this case, the print server 4 transmits part or all of the electronic money data to the electronic money issuer server for the check of the validity of the electronic money, and transmits the print data to the printer 3 in accordance with the result of the check of validity of the electronic money from the electronic money issuer server. The printer 3 executes print processing based on the transmitted print data.

The user side subsystem may consist of only the user's PC. The printer side subsystem may consist of only a printer. The electronic money issuer side subsystem may consist of only an electronic money issuer server.

While the Internet or a LAN is used as the network, a different network may be used.

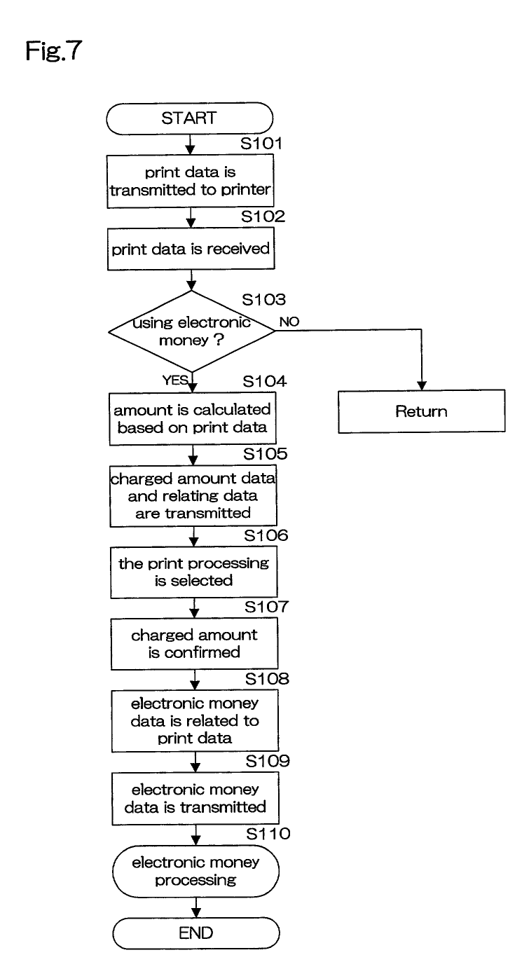

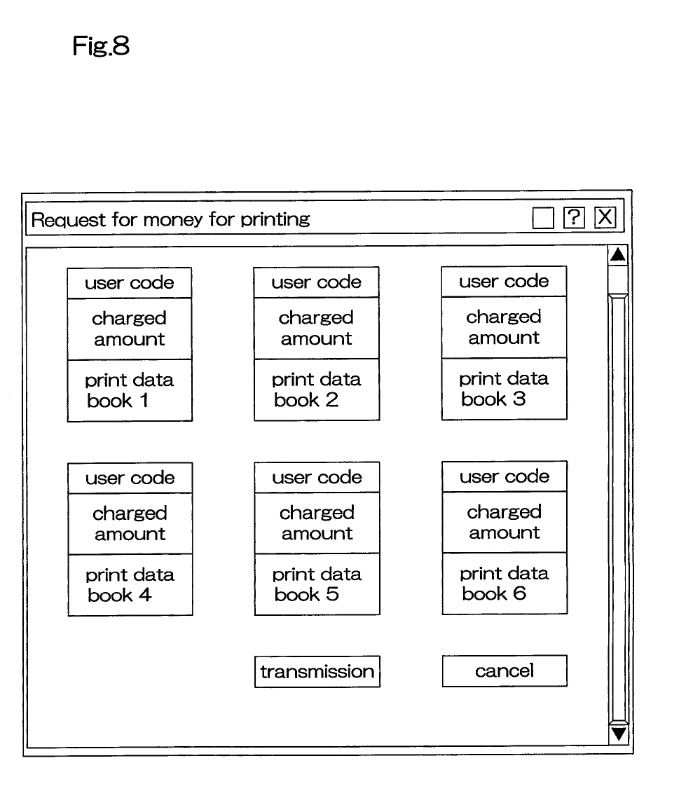

The relating of the electronic money data and the print data is performed by the printer. However, it may be performed by an apparatus other than the printer 3, for example, the print server 4, the electronic money processing server 2 or the PC 1, or relating may be performed separately on the electronic money data and on the print data by different apparatuses. An example in which the printer 3 performs relating on the print data and the PC 1 performs relating on the electronic money data will be described with reference to FIGS. 7 and 8.

First, at S101, the PC 1 transmits print data to the printer 3 through the network. Then, the printer 3 receives the print data at S102, and determines whether the print data uses electronic money or not at S103. When the print data does not use electronic money (NO at S103), the process returns. When the print data uses electronic money (YES at S103), the necessary amount of electronic money is calculated based on the print data at S104, and the charged electronic money amount data is transmitted to the user's PC1 together with the relating data corresponding to the print data at S105. The print data at this time is temporarily stored in the printer 3.

Then, at S106, the charged amount of electronic money corresponding to each print data is displayed on the display portion of the user's PC 1 as shown in FIG. 8. Consequently, the user selects a print processing he desires with a mouse cursor or the like, and confirms the charged amount of electronic money at S107. Then, the process proceeds to S108.

At S108, the PC 1 attaches electronic money data to the relating data to thereby relates the electronic money data to the print data, and at S109, transmits to the printer 3 the relating data to which the electronic money data is attached. Then, like in the above-described embodiment, the printer 3 determines whether the electronic money is valid or not, and then, executes print processing based on the print data related to the electronic money data.

In the above-described embodiment, the check of the validity of the electronic money is entrusted to the issuer of the electronic money. However, the check of the validity of the electronic money may be entrusted to a third-party authentication institution other than the issuer of the electronic money.

According to the above-described embodiment, since processing is performed after the electronic money is confirmed to be valid, processing can be prevented from being executed based on processing request data for which payment cannot be made, so that payment can be made easily and reliably. Consequently, it never occurs that predetermined processing is performed when the electronic money cannot be used for payment or the electronic money data is corrupted due to a trouble, so that misprocessing and invalid processing can be prevented.

According to the above-described embodiment, since the electronic money processor checks whether the electronic money is valid or not and controls the execution of the processing in accordance with the result of the check, processing can be prevented from being executed based on processing request data for which payment cannot be made, so that payment can be made easily and reliably.

According to the above-described embodiment, the user can also easily determine whether the electronic money is valid or not.

According to the above-described embodiment, since the electronic money processor checks whether the electronic money is valid or not and executes processing based on the processing request data in the image forming portion in accordance with the result of the check, processing can be prevented from being executed based on processing request data for which payment cannot be made, so that payment can be made easily and reliably in the image forming apparatus.

According to the above-described embodiment, since the electronic money data and the processing request data are related so as to be associatable with each other and the processing request data corresponding to each electronic money data can be grasped easily and reliably, the electronic money data and the processing request data can be processed parallelly. Consequently, the waiting time for payment by electronic money and the entire processing can be reduced.

According to the above-described embodiment, since the data relating apparatus relates the processing request data and the electronic money data transmitted to the electronic money issuer side subsystem to clarify the correspondence between the processing request data and the electronic money data, the above-described method for making payment by electronic money can be realized easily and reliably.

According to the above-described embodiment, the processing request data and the electronic money data can be related easily and reliably in the processor side subsystem.

According to the above-described embodiment, the user can easily and reliably grasp the necessary amount of electronic money for the processing request data.

According to the above-described embodiment, since the data relating apparatus relates the processing request data and the electronic money data transmitted to the issuer of the electronic money to clarify the correspondence between the processing request data and the electronic money data on the side of the processor, the above-described method for making payment by electronic money can be realized easily and reliably. It is desirable that the data relating apparatus be included in the data processor or the server computer that manages the data processor in the processor side subsystem.

According to the above-described embodiment, since the electronic money data and the processing request data (for example, print data) are related so as to be associatable with each other in the image forming apparatus and the processing request data corresponding to each electronic money data can be grasped easily and reliably, the electronic money data can be treated parallelly, so that in image formation performed at the user's request, the waiting time for payment by electronic money can be reduced.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An information processing method comprising the steps of:
receiving, through a network, data to be information-processed and electronic money by which payment for information processing is made;
making a request that whether the received electronic money is valid or not be checked; and
when the received electronic money is confirmed to be valid, automatically starting the processing of the data to be information-processed.

2. An information processing method comprising the steps of:
receiving, through a network, data to be information-processed and electronic money by which payment for information processing is made;
relating the received data to be information-processed and the electronic money by which payment for information processing is made;
making a request that whether the received electronic money is valid or not be checked; and
when the received electronic money is confirmed to be valid, performing the processing of the data to be information-processed related to the electronic money confirmed to be valid.

3. An electronic payment method comprising the steps of:
receiving, through a network, data to be information-processed and electronic money by which payment for information processing is made;
associating the data with the electronic money;
making a request that whether the received electronic money is valid or not be checked; and
when the received electronic money is confirmed to be valid, starting the processing of the data which is associated with the valid electronic money.

4. A system for making payment by electronic money in which a user side subsystem including a user is terminal, an electronic money issuer side subsystem including an electronic money issuing server and a processor side subsystem including a data processor that performs a processing based on processing request data from the user are connected to one another through a network,
wherein the processing request data and electronic money data including electronic money issued by the electronic money issuer side subsystem are transmitted from the user side subsystem to the processor side subsystem, the electronic money data is further transmitted from the processor side subsystem to the electronic money issuer side subsystem, whether the electronic money is valid or not is checked, and the processor side subsystem performs the processing based on the processing request data in accordance with a result of the check and transmits a request for payment for the processing to the electronic money issuer side subsystem.

5. An electronic money processor comprising:
receiving member which receives processing request data transmitted from a user through a network and based on which a processing requested by the user is executed, and electronic money data transmitted from the user through the network and including electronic money issued by an electronic money issuer;
memory in which the processing request data received by the receiving member is stored;
transmitter which transmits the electronic money data received by the receiving member to the electronic money issuer to check whether the electronic money is valid or not; and
execution controller which controls execution of the processing based on the processing request data corresponding to the electronic money data and stored in the memory in accordance with a result of the check of validity of the electronic money.

6. An electronic money processor as claimed in claim 5, wherein when the electronic money is not confirmed to be valid, said transmitter transmits warning information that the electronic money is not confirmed to be valid, to the user who transmitted the electronic money data including the electronic money.

7. An image forming apparatus comprising the electronic money processor as claimed in claim 5, further comprising:
an image forming portion in which execution of the processing based on the processing request data is controlled by the execution control means of the electronic money processor.
